(19) United States
(12) Patent Application Publication
(10) Pub. No.: US 2024/0198726 A1
(43) Pub. Date: Jun. 20, 2024

(54) Caster with Compliant Brake Ring or Brake Block

(71) Applicant: Colson Group Holdings, LLC, Oakbrook Terrace, IL (US)

(72) Inventor: David Paul Beatty, Stevensville, MI (US)

(21) Appl. No.: 18/521,227

(22) Filed: Nov. 28, 2023

Related U.S. Application Data
(60) Provisional application No. 63/433,860, filed on Dec. 20, 2022.

(51) Int. Cl. B60B 33/00

(52) U.S. Cl. CPC B60B 33/0086

(57) ABSTRACT

A caster hub structure has an outward facing brake ring with a tooth profile on its outer surface. A brake block with a tooth profile on its outer surface is engageable and disengageable with the brake ring. The brake block material may be harder than the brake ring material, or the brake ring material may be hardness the brake block material, depending upon the application. The brake block tooth profile is configured to slip with the brake ring tooth profile at a first wheel rotational speed when the brake block is engaged with the brake ring, and the brake block tooth profile is configured to interlock with the brake ring tooth profile at a second wheel rotational speed when the brake block is in the engaged with the brake ring, the first speed being higher than the second speed.

### RELATED APPLICATION DATA

The present application claims priority benefit to U.S. provisional application Ser. No. 63/433,860, filed Dec. 20, 2022, the disclosure of which is incorporated by reference herein.

### BACKGROUND & SUMMARY

The present disclosure is directed to a caster with a brake system comprising a brake block and a brake ring on an outer diameter surface of a wheel hub structure of the caster. In one aspect, the brake ring is made from a material that is resilient or compliant, and the brake block is made from a material harder than the brake ring. The brake ring and brake block each have a tooth profile. The tooth profile of the brake ring and the brake block are configured to allow relative slip between the brake block and brake ring at a first speed of rotation of the wheel with the brake block engaged with the brake ring and to allow interlocking of the brake block with the brake ring at a second speed of rotation of the wheel that is less than the first speed of rotation of the wheel. In other words, when the brake block engages the brake ring, the brake ring may engage the brake ring to begin to slow the rotation of the caster wheel. Because the brake ring is compliant and the brake block is made from a harder material, the brake block may deform the brake ring to allow slip and without the tooth profile of the brake block interlocking with the tooth profile of the brake ring. With the brake block engaged, the wheel may continue to slow rotation until a level such that the tooth profile of the brake ring interlocks with the tooth profile of the brake block to thereafter prevent rotation of the wheel. The brake ring may slowly return to its undeformed state to allow the tooth profile of the brake ring to interlock with the tooth profile of the brake block to prevent rotation of the wheel.

In another aspect, the brake block is made from a material that is resilient or compliant, and the brake ring is made from a material harder than the brake ring. The tooth profile of the brake ring and the brake block are configured to allow relative slip between the brake block and brake ring at a first speed of rotation of the wheel with the brake block engaged with the brake ring and to allow interlocking of the brake block with the brake ring at a second speed of rotation of the wheel that is less than the first speed of rotation of the wheel. Because the brake block is compliant and the brake ring is made from a harder material, the brake block may deform when engaged with the brake ring to allow slip and without the tooth profile of the brake block interlocking with the tooth profile of the brake ring. With the brake block engaged, the wheel may continue to slow rotation until a level such that the tooth profile of the brake ring interlocks with the tooth profile of the brake block to thereafter prevent rotation of the wheel. The brake block may slowly return to its undeformed state to allow the tooth profile of the brake ring to interlock with the tooth profile of the brake block to prevent rotation of the wheel.

### DESCRIPTION OF DRAWINGS

FIG. 1 is a perspective view showing a caster according to a first embodiment of the present disclosure.

FIG. 2 is a left side elevational view of the caster shown in FIG. 1.

FIG. 3 is a left side elevational view of the caster of FIG. 1 with the wheel and some of the hub structure removed to provide detail of a braking ring and braking block of the caster.

FIG. 4 is a further left side sectional view of the caster shown in FIG. 1 with additional structure removed to provide additional detail of the caster.

FIG. 5 is a further left side sectional view of the caster shown in FIG. 1 with additional structure removed to provide additional detail of the caster.

FIG. 6 is a rear side sectional view of the caster shown in FIG. 1 with additional structure removed to provide additional detail of the caster.

FIG. 7 is a further rear side sectional view of the caster shown in FIG. 1 with additional structure removed to provide additional detail of the caster.

FIG. 8 is an enlarged view from detail area 8-8 of FIG. 3.

### DETAILED DESCRIPTION

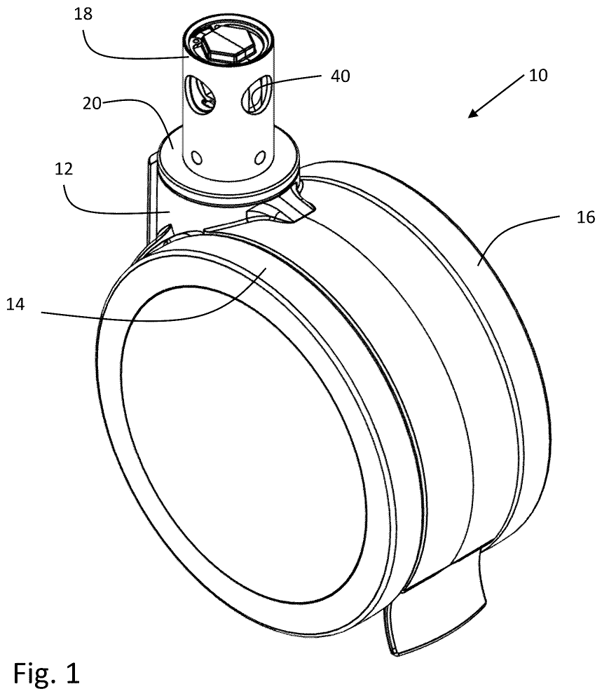

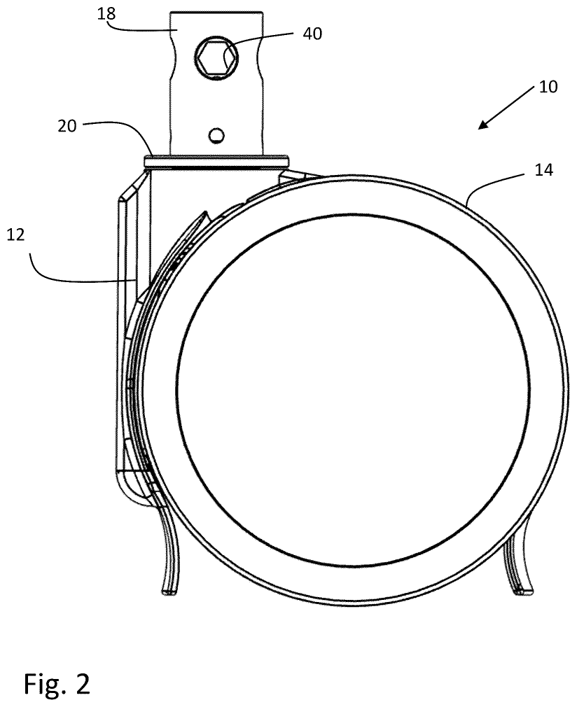

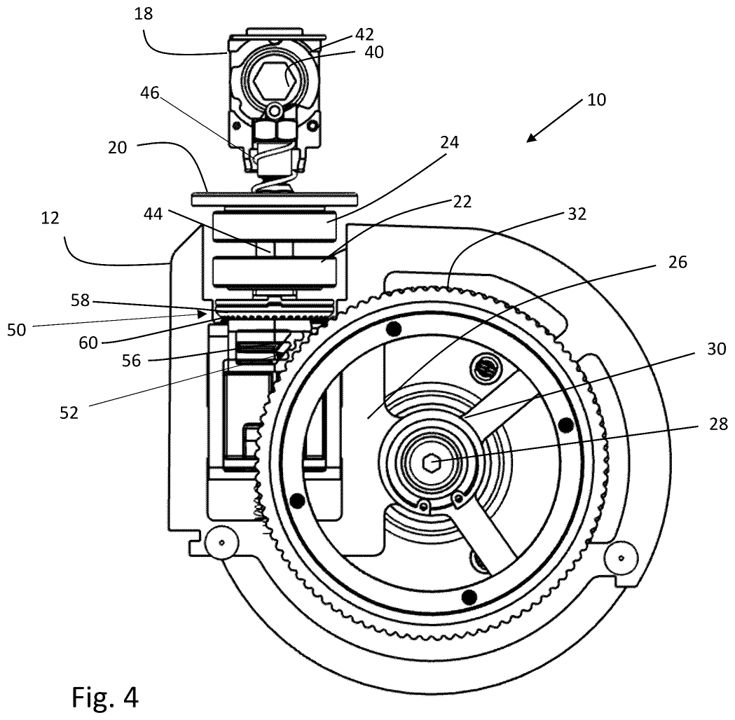

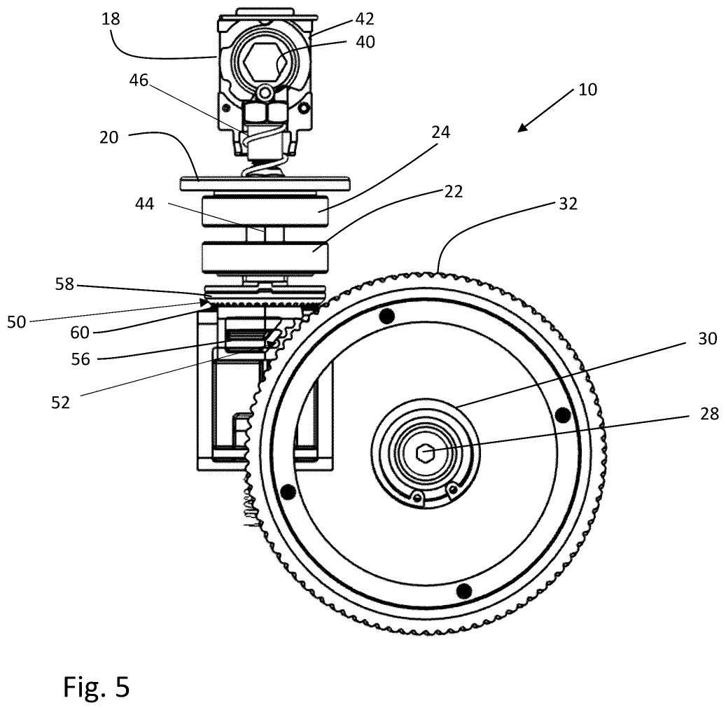

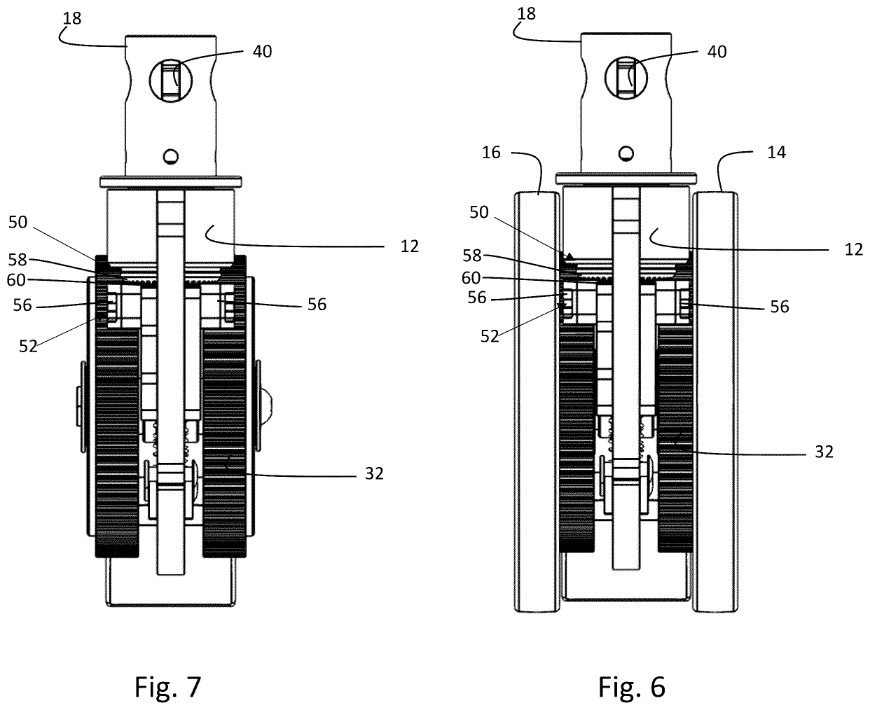

Referring to FIGS. 1 to 7, the exemplary caster 10 may be coupled to a movable object (not shown) to support and move the movable object. The movable object to which the caster device 10 is coupled may include, but is not limited to, a movable bed or a medical appliance such as an ultrasonic diagnostic apparatus. Further, the movable object may be any movable object to which the caster 10 can be coupled, such as a cart designed to carry articles. The caster 10 may be coupled to a lower side of the movable object. Although the drawings show a dual wheel caster, the principles of the disclosure may be applied to a single wheel caster, or other arrangement and are not intended to be limiting. For the sake of brevity and not in any limiting sense, the disclosure that follows below will address a dual wheel arrangement of a caster for purposes of illustrating the principles of the disclosure but such principles apply equally with respect to a single wheel or other arrangement for a caster.

The caster 10 may include a body 12, left and right wheels 14,16 projecting from the body, and a stem 18 projecting from the body to provide swivel connection to the movable object. A base 20 rotatable with the stem 18 may be provided at the bottom of stem to further support the movable object. A rotary bearing 22 may be operatively disposed between the body 12 and the stem 18 for swivel rotation, and a thrust bearing 24 may be disposed between the body and the base 20. The body 12 may include a fork portion 26 that supports an axle 28 and/or hub structure 30 of the wheel 14,16. The hub structure 30 of the wheel 14,16 may include a brake ring 32 with a smooth saw tooth profile extending around the peripheral edge of the brake ring.

The stem 18 may be provided with an actuator 40 that allows the caster to be placed in one of a plurality of operating modes by reciprocating rotation of the actuator. A crank shaft (not shown) may be coaxially connected or coupled to the actuator 40 of the caster 10. The actuator 40 may cooperate with a cam element 42 disposed in the stem. The actuator 40 may be operatively connected with the cam element 42 so rotation of the actuator repositions the cam element and sets the operating mode of the caster. A push rod 44 may have first and second ends and extend vertically in the stem and through an upper hollow interior of the body. An end of the push rod 44 may be operatively connected with a compression spring 46 in the caster body that urges the push rod vertically upward so the push rod engages against the cam element 42. Between the first and second ends, the push rod may have a releasable connection with a swivel lock 50 of the caster and/or a releasable connection with a brake lock 52.

The cam element 42 may have three or more cam surfaces that may be brought to bear on the second end of a push rod 44 and set the vertical position of the push rod to release or form the connection with the swivel lock 50 and/or release or form the connection with the brake lock 52. In one aspect, a brake block 56 may be attached toward a lower or first end of the push rod 44, and a face gear engagement piece 58 may be integrally attached to the push rod above the brake block. The brake block 56 may selectively engage the complementary brake ring 32 to form the wheel lock 52. The face gear engagement piece 58 may selectively engage a complementary locking gear 60 formed in the upper portion of the body below the rotary bearing 22 to form the swivel lock 50.

The cam element 42 may have first, second and third cam surfaces on its periphery, each of which is sized in a radial direction from a rotating axis. As the second end of the push rod 44 contacts the cam surfaces of the cam element 42 under the biasing force of the compression spring 46, the push rod may be vertically and resiliently movable due to the reciprocating rotation of the cam element 42 about the rotating axis, thus allowing the caster to operate in first, second and third modes. In the first mode, the second end of the push rod 44 may be engaged with the first cam surface of the cam element. The push rod 44 may be vertically positioned in a manner such that the face gear engagement piece 58 may be separated from the locking gear 60 of the body 12 and the brake block 56 may be separated from the brake ring 32 of the wheel hub 30. Thus, the stem 18 of the caster may swivel or rotate to change the moving direction and the wheel 14,16 may rotate. In the second mode, the second end of the push rod 44 may contact the second cam surface of the cam element. In the second mode, the push rod 44 may move downwardly to bring the face engagement gear 58 in interlocking registry with the locking gear 60 in the body 12, thus preventing rotation about the swivel axis while maintaining the brake block 56 disengaged from the brake ring 32. Thus, in the second mode, swiveling may be locked in position, but the wheel may be free to rotate. As explained below in more detail, in the third mode, the second end of the push rod 44 may be engaged with the third cam surface of the cam element. In the third mode, the push rod 44 may be vertically positioned in a manner such that the face gear engagement piece 58 may be engaged to the locking gear 60 in the body 12 and the brake block 56 may be brought into contact with the brake ring 58. Thus, in the third mode, swiveling may be locked in position, and the wheel may be prevented from rotation.

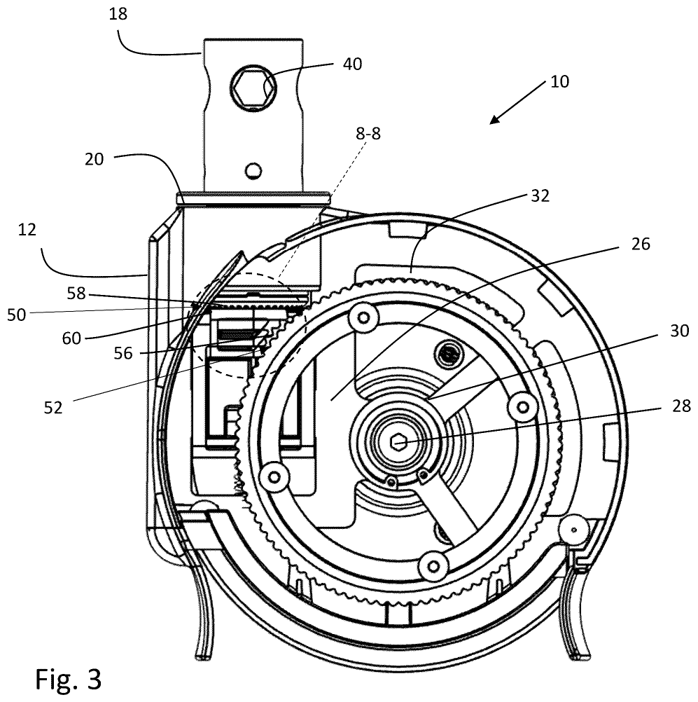

As best shown in FIGS. 3-5, the brake block 56 has a shallow tooth pattern that is engageable and interlockable with the shallow tooth pattern of the brake ring 32. The outer surface of the brake ring 32 has a shallow tooth profile patterned around the outer diameter surface of the brake ring. In one aspect, the brake ring 32 has a material on its outer surface that is compliant and deformable. The brake ring material and tooth profile allows the outer surface of the brake ring to compress/deform when engaged by the brake block. By way of example and not in any limiting sense, the outer surface of the brake ring may be formed form an elastomer. The brake block 56 may be more rigid than the brake ring. By way of example and not in any limiting sense, the brake block may be formed of a plastic material. The brake block may have a shallow tooth profile that complements the tooth profile on the brake ring.

In another aspect, the brake block has a material on its outer surface that is compliant and deformable. The brake block material and tooth profile allows the outer surface of the brake block to compress/deform when engaged by the brake ring. In the aforementioned embodiment, by way of example and not in any limiting sense, the outer surface of the brake block may be formed form an elastomer. The brake ring may be more rigid than the brake block. In the aforementioned embodiment, by way of example and not in any limiting sense, the brake ring may be formed of a plastic material. The brake ring may have a shallow tooth profile that complements the tooth profile on the brake ring.

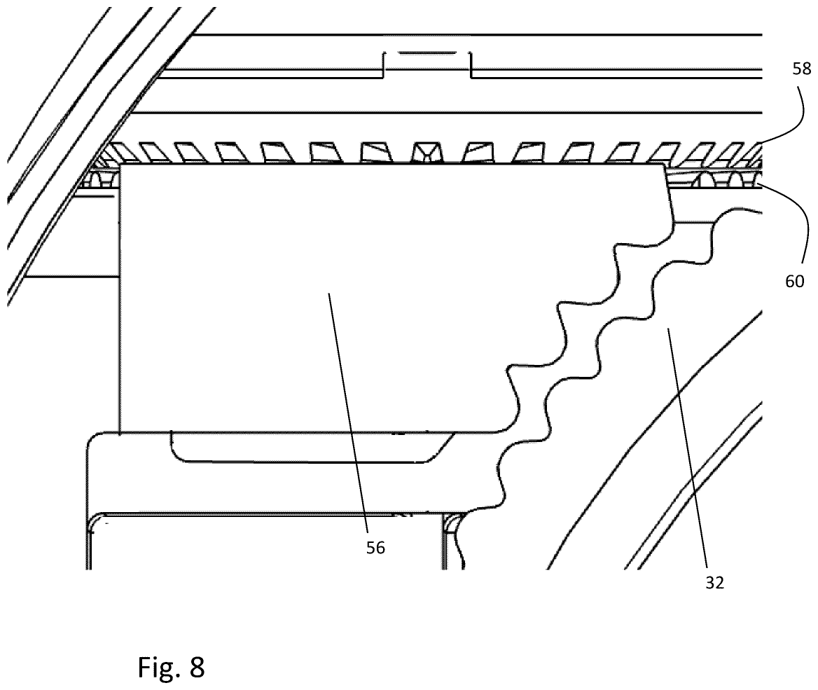

When activated, for instance, in the third mode, the brake block 56 may be driven into the brake ring 32 via the action of the push rod 44. In the drawings, the push rod 44 is moved downward which corresponds to the motion of the brake block 56 relative to the brake ring 32. That is, the brake block moves in a vertical direction within the body when moving between the engaged and disengaged positions. In one aspect, the brake ring 32 material deflects and/or deforms upon engagement and thereafter the tooth profile of the brake ring interlocks with the tooth profile of the brake block 56. In another aspect, the brake block material deflects and/or deforms upon engagement and thereafter the tooth profile of the brake ring interlocks with the tooth profile of the brake block. The tooth profile of the brake block 56 and brake ring 32 is somewhat rounded at the tips of the teeth to allow relative motion or slip between the brake block and brake ring 32 during engagement until the tooth profile of the brake ring interlocks with the tooth profile of the brake block. For instance, as best shown in FIG. 8, each tooth in the plurality of teeth of the brake block is defined by a rounded outer edge disposed between rounded inner edges, and each tooth in the plurality of teeth of the brake ring is defined by a rounded outer edge disposed between rounded inner edges. In both cases, the rounded outer edge has a first curvature and the rounded inner edge has a second curvature that is less than the first curvature. As to the first and second curvature, the teeth may be formed with a single radius or a more general type of curvature with multiple radii defining the curvature. In each case of the brake ring teeth and the brake block teeth, the curvature of the rounded outer edge is greater than the curvature of the adjacent rounded inner edges.

In this way, the tooth profile of the brake ring and the brake block are configured to allow relative slip between the brake block and brake ring at a first speed of rotation of the wheel with the brake block engaged with the brake ring and to allow interlocking of the brake block with the brake ring at a second speed of rotation of the wheel that is less than the first speed of rotation of the wheel. In other words, when the brake block engages the brake ring, the brake ring may engage the brake ring to begin to slow the rotation of the caster wheel. Because the brake ring (or brake block, as the case may be) is compliant and the brake block (or brake ring, as the case may be) is made from a harder material, the brake block (or brake ring) may deform to allow slip and without the tooth profile of the brake block interlocking with the tooth profile of the brake ring. With the brake block engaged, the wheel may continue to slow rotation until a level such that the tooth profile of the brake ring interlocks with the tooth profile of the brake block to thereafter prevent rotation of the wheel. The brake ring (or brake block, as the case may be) may slowly return to its undeformed state to allow the tooth profile of the brake ring to interlock with the tooth profile of the brake block to prevent rotation of the wheel. This allows the brake 52 to be activated, for instance, in the third mode, while caster is in motion and allows for a progressive reduction in speed before unit comes to a complete stop.

While the drawings show a caster with a stem operator adapted and configured to set three modes of operation of the caster, the principles of the compliant brake ring described above may be used in connection with other types of casters and wheels.

The principle and embodiments of the present application are described through specific examples herein. The description of the above-described embodiments is merely used to facilitate understanding the method and core idea of the present application. It should be noted that, for those skilled in the art, various improvements and modifications may be further made to the present application without departing from the principle of the present application, and these improvements and modifications also fall within the protection scope defined by the claims of the present application.

What is claimed:

1. A caster comprising:
a body;
a wheel operatively rotatably connected to the body;
a hub structure operatively connected to the wheel, the hub structure having an outward facing brake ring, the brake ring being formed of a radially compliant material, the brake ring having a tooth profile on an outer surface of the brake ring; and
a brake block adapted and configured for reciprocating motion within the body between an engaged position with the brake ring and a disengaged position with the brake ring, the brake block being formed of a material having a hardness greater than the hardness of the material of the brake ring, the brake block having a tooth profile on an outer surface of the brake block;
wherein the tooth profile of the brake block is adapted and configured to slip with the tooth profile on the outer surface of the brake ring at a first speed of rotation of the wheel when the brake block is in the engaged position, and the tooth profile of the brake block is adapted and configured to interlock with the tooth profile on the outer surface of the brake ring at a second speed of rotation of the wheel when the brake block is in the engaged position, the first speed being higher than the second speed;
wherein when the brake block is in the engaged position relative to the brake ring, the brake block engages the brake ring in a manner so as to enable relative motion between the brake block and brake ring at the first speed of rotation of the wheel and to limit relative motion between the brake block and the brake ring at the second speed of rotation of the wheel; and
wherein when the brake block is in the disengaged position relative to the brake ring, the brake block is spaced from the brake ring in a manner so as to allow free rotation of the wheel relative to the body.

2. The caster of claim 1 wherein brake ring is coaxially aligned with an axis of rotation of the wheel.

3. The caster of claim 1 wherein the hub structure has an annular surface with the brake ring being mounted on the annular surface.

4. The caster of claim 1 where the brake ring is formed of an elastomer material.

5. The caster of claim 1 wherein the tooth profile of the brake block having rounded outer edges.

6. The caster of claim 1 wherein the tooth profile on the outer surface of the brake ring having rounded outer edges.

7. The caster of claim 1 wherein the brake block is made of a plastic material.

8. The caster of claim 1 wherein the brake block moves in a vertical direction within the body when moving between the engaged and disengaged positions.

9. A caster comprising:
a body;
a wheel operatively rotatably connected to the body;
a hub structure operatively connected to the wheel, the hub structure having an outward facing brake ring, the brake ring having a plurality of teeth arranged in a pattern on an outer surface of the brake ring; and
a brake block adapted and configured for reciprocating motion within the body between an engaged position with the brake ring and a disengaged position with the brake ring, the brake block having a plurality of teeth on an outer surface of the brake block;
wherein the brake ring is formed of a material sufficiently radially compliant such that wherein when the brake block is in the engaged position relative to the brake ring, the brake block engages the brake ring in a manner so as to allow relative motion between the brake block and the brake ring, and after rotation of the wheel, enable at least one of the teeth in the plurality of teeth of the brake block to interlock with at least one of the teeth in the plurality of teeth on the outer surface of the brake ring; and
wherein when the brake block is in the disengaged position relative to the brake ring, the brake block is spaced from the brake ring in a manner so as to allow free rotation of the wheel relative to the body.

10. The caster of claim 9 wherein brake ring is coaxially aligned with an axis of rotation of the wheel.

11. The caster of claim 9 wherein the hub structure has an annular surface with the brake ring being mounted on the annular surface.

12. The caster of claim 9 where the brake ring is formed of an elastomer material.

13. The caster of claim 9 wherein each tooth of the tooth profile of the brake block has rounded outer edges.

14. The caster of claim 9 wherein each tooth in the plurality of teeth on the outer surface of the brake ring has rounded outer edges.

15. The caster of claim 9 wherein the brake block is made of a plastic material.

16. The caster of claim 9 wherein the brake block moves in a vertical direction within the body when moving between the engaged and disengaged positions.

17. The caster of claim 9 wherein each tooth in the plurality of teeth of the brake block is defined by a rounded outer edge disposed between rounded inner edges, the rounded outer edge has a first curvature, the rounded inner edge has a second curvature, the first curvature is greater than the second curvature.

18. The caster of claim 9 wherein each tooth in the plurality of teeth of the brake ring is defined by a rounded outer edge disposed between rounded inner edges, the rounded outer edge has a first curvature, the rounded inner edge has a second curvature, the first curvature is greater than the second curvature.

19. The caster of claim 9 wherein the plurality of teeth of the brake ring are adapted and configured to slip with the plurality of teeth of the brake block at a first speed of rotation of the wheel when the brake block is in the engaged position and interlock with the plurality of teeth of the brake block at a second speed of rotation of the wheel when the brake block is in the engaged position, the first speed is greater than the second speed.

20. A caster comprising:
a body;
a wheel operatively rotatably connected to the body;
a hub structure operatively connected to the wheel, the hub structure having an outward facing brake ring, the brake ring having a plurality of teeth arranged in a pattern on an outer surface of the brake ring; and
a brake block adapted and configured for reciprocating motion within the body between an engaged position with the brake ring and a disengaged position with the brake ring, the brake block having a plurality of teeth on an outer surface of the brake block;
wherein the brake block is formed of a material sufficiently radially compliant such that wherein when the brake block is in the engaged position relative to the brake ring, the brake block engages the brake ring in a manner so as to allow relative motion between the brake block and the brake ring, and after rotation of the wheel, enable at least one of the teeth in the plurality of teeth of the brake block to interlock with at least one of the teeth in the plurality of teeth on the outer surface of the brake ring; and
wherein when the brake block is in the disengaged position relative to the brake ring, the brake block is spaced from the brake ring in a manner so as to allow free rotation of the wheel relative to the body.

21. The caster of claim 20 wherein brake ring is coaxially aligned with an axis of rotation of the wheel.

22. The caster of claim 20 wherein the hub structure has an annular surface with the brake ring being mounted on the annular surface.

23. The caster of claim 20 where the brake block is formed of elastomer material.

24. The caster of claim 20 wherein each tooth of the tooth profile of the brake block has rounded outer edges.

25. The caster of claim 20 wherein each tooth in the plurality of teeth on the outer surface of the brake ring has rounded outer edges.

26. The caster of claim 20 wherein the brake ring is made of a plastic material.

27. The caster of claim 20 wherein the brake block moves in a vertical direction within the body when moving between the engaged and disengaged positions.

28. The caster of claim 20 wherein each tooth in the plurality of teeth of the brake block is defined by a rounded outer edge disposed between rounded inner edges, the rounded outer edge has a first curvature, the rounded inner edge has a second curvature, the first curvature is greater than the second curvature.

29. The caster of claim 20 wherein each tooth in the plurality of teeth of the brake ring is defined by a rounded outer edge disposed between rounded inner edges, the rounded outer edge has a first curvature, the rounded inner edge has a second curvature, the first curvature is greater than the second curvature.

30. The caster of claim 20 wherein the plurality of teeth of the brake ring are adapted and configured to slip with the plurality of teeth of the brake block at a first speed of rotation of the wheel when the brake block is in the engaged position and interlock with the plurality of teeth of the brake block at a second speed of rotation of the wheel when the brake block is in the engaged position, the first speed is greater than the second speed.
